(19) United States
(12) Patent Application Publication
(10) Pub. No.: US 2006/0150210 A1
(43) Pub. Date: Jul. 6, 2006

(54) System for simulating the presence of a person in a room

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/544,826

(22) PCT Filed: Feb. 9, 2004
(86) PCT No.: PCT/IB04/50084

§ 371 Date: Aug. 5, 2005

(30) Foreign Application Priority Data
Feb. 10, 2003 (EP) 03100273.6

(51) Int. Cl. H04N 7/173; H04H 9/00; H04N 7/16

(52) U.S. Cl. 725/10; 725/9; 725/88

(57) ABSTRACT

A system for simulating the presence of a person in a room has first playback means (11) for playing back sound and/or image information and activation signal generation means (52) for repeatedly generating an activation signal (AS), and activation means (53) for automatically repeatedly activating the first playback means (11) as a function of the occurrence of the activation signal (AS), following which activation of the first playback means (11) sound and/or image information can be transmitted, by means of which transmittable sound and/or image information the presence of a person in a room can be simulated, and standby means (18) for activating/deactivating a standby mode of operation of at least the first playback means (11), and switching means for switching at least the first playback means (11) of the system between a simulation mode of operation and an entertainment mode of operation, in which simulation mode of operation it is possible to simulate the presence of a person in a room and in which entertainment mode of operation it is possible for a user to switch at least the first playback means (11) between the standby mode of operation and the entertainment mode of operation.

The present invention relates to a system for simulating the presence of a person in a room, which system comprises the following means, namely: first playback means for playing back sound and/or image information and activation signal generation means for repeatedly generating an activation signal, and activation means for automatically repeatedly activating the first playback means as a function of the occurrence of the activation signal, following which activation of the first playback means sound and/or image information can be transmitted, by means of which transmittable sound and/or image information the presence of a person in a room can be simulated.

The present invention furthermore relates to a method of simulating the presence of a person in a room, in which method the following steps are carried out, namely: playback of sound and/or image information by means of first playback means, and repeated generation of an activation signal, and automatic repeated activation of the first playback means as a function of the occurrence of the activation signal, following which activation of the first playback means sound and/or image information is transmitted, by means of which transmitted sound and/or image information the presence of a person in a room is simulated.

A system and method such as those mentioned above are known in connection with the document U.S. Pat. No. 5,258,656. Disclosed therein is an electronic time control device which is designed as activation signal generation means for repeatedly generating an activation signal and with the aid of which the supply of electrical power to an external (electrical) playback device, which can be connected to this time control device, can be controlled via activation means, that is to say automatic repeated activation of the playback device is made possible. In the case of activation such as this, sound and/or image signals can be transmitted by the playback device, specifically for simulating or feigning the presence of a person in a room or for simulating that a room (for example an apartment, house, etc.) is occupied. Simulation of this type is used as a deterrent and is intended to minimize the risk of unauthorized persons (e.g. burglars, vandals, etc.) with criminal intent gaining access to such a room or to such premises when said room or said premises is/are unused or unoccupied. Examples of such externally connectable devices are radios, stereo systems or TVs. A problem which arises when controlling such radios and/or TVs in this way is that it is only possible to control those radios and/or TVs which directly enter a playback mode once the electrical power supply has been switched on, in which playback mode the sound and/or image signals are transmitted. However, such a condition is not possible in the case of more modem radios or TVs which have what is known as a standby mode, and this is disadvantageous. A radio or TV of this type initially merely enters the standby mode when the power supply is switched on. In order to pass from the standby mode to the playback mode, user intervention is required, e.g. activation of the playback mode by means of a remote control unit.

A further disadvantage of the known system is that, in the case of such devices with a standby mode, the current time setting and presets may be lost or deleted following a break in the power supply if there are no nonvolatile storage means for storing such presets, as is the case with a relatively large number of playback devices of this type that are commercially available. For example, in the case of radios having an alarm function, the alarm time has to be reset following a break in the power supply, and this is often laborious and awkward and therefore disadvantageous.

It is an object of the invention to overcome the abovementioned disadvantageous conditions and to provide an improved system and an improved method.

To achieve the abovementioned object, a system according to the invention has features according to the invention, so that a system according to the invention can be characterized in the manner indicated below, namely:

system for simulating the presence of a person in a room, which system comprises the following means, namely: first playback means for playing back sound and/or image information and activation signal generation means for repeatedly generating an activation signal, and activation means for automatically repeatedly activating the first playback means as a function of the occurrence of the activation signal, following which of the first playback means activation sound and/or image information can be transmitted, by means of which transmittable sound and/or image information the presence of a person in a room can be simulated, and standby means for activating/deactivating a standby mode of operation of at least the first playback means, and switching means for switching at least the first playback means of the system between a simulation mode of operation and an entertainment mode of operation, in which simulation mode of operation it is possible to simulate the presence of a person in a room and in which entertainment mode of operation it is possible for a user to switch at least the first playback means between the standby mode of operation and the entertainment mode of operation.

To achieve the abovementioned object, a method according to the invention also has features according to the invention, so that a method according to the invention can be characterized in the manner indicated below, namely:

method of simulating the presence of a person in a room, in which method the following steps are carried out, namely: playback of sound and/or image information by means of first playback means, and repeated generation of an activation signal, and automatic repeated activation of the first playback means as a function of the occurrence of the activation signal, following which activation of the first playback means sound and/or image information is transmitted, by means of which transmitted sound and/or image information the presence of a person in a room is simulated, and activation/deactivation of a standby mode of operation of at least the first playback means, and switching of at least the first playback means of the system between a simulation mode of operation and an entertainment mode of operation, in which simulation mode of operation the presence of a person in a room is simulated and in which entertainment mode of operation a user switches at least the first playback means between the standby mode of operation and the entertainment mode of operation.

By providing the features according to the invention, an improved system and an improved method are obtained in a very simple manner and using simple means. One particular advantage is that a user can use such a system in an entertainment mode of operation, wherein the advantages of a standby mode of operation can be used and wherein a switch can be made to a simulation mode of operation for the purpose of simulating or feigning the presence of a person in a room. In the case of simulation such as this, first playback means can be activated within a predefined time program in order to play back sound and/or image information, which sound information or sound and image information simulates the presence of a person in a room or that a room is occupied, and as a result potential burglars can be deterred from breaking into the room and possibly other rooms.

In a system according to the invention, it has proven to be particularly advantageous when the features as claimed in claim 2 are also provided. These measures, which are known per se, are also advantageous in connection with a system according to the invention since, as a result, a more realistic and believable simulation or feigning of the presence of a person in a room is made possible with a system according to the invention.

It has proven to be particularly advantageous when the features as claimed in claim 3 or claim 11 are also provided in a system or method according to the invention. This is particularly advantageous with regard to the simple creation of sound information or sound and image information for the purpose of simulating or feigning the presence of a person in a room, since a particularly realistic and believable simulation is made possible.

The first playback means may be designed to play back sound and/or image information that is recorded on magnetic tape. It has proven to be particularly advantageous when the features as claimed in claim 4 or claim 12 and claim 5 are also provided in a system or method according to the invention. As a result, it is possible to simulate or feign the presence of a person in a room in a particularly simple manner.

It has proven to be very advantageous when the features as claimed in claim 6 or claim 13 are also provided in a system or method according to the invention. This ensures that the simulation or feigning of the presence of a person in a room is still possible even in the event of a malfunction of the first playback means.

The abovementioned aspects and further aspects of the invention emerge from the following description of an example of an embodiment and are explained on the basis of this example of an embodiment.

The invention will be further described with reference to an example of an embodiment shown in the drawings to which, however, the invention is not restricted.

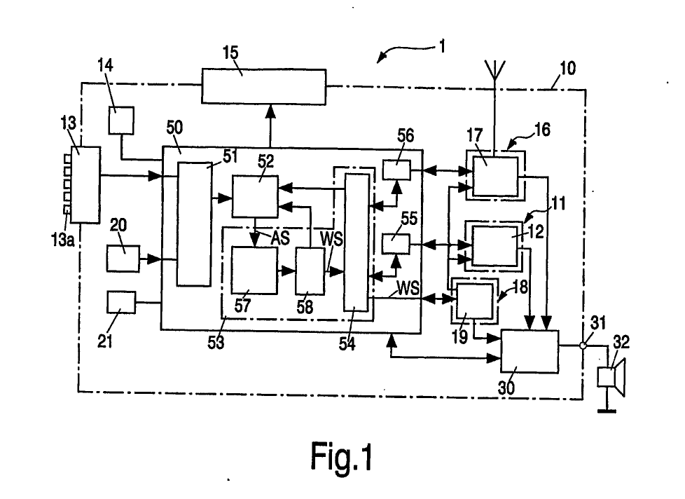

FIG. 1 shows, in the form of a block diagram, a system according to the invention.

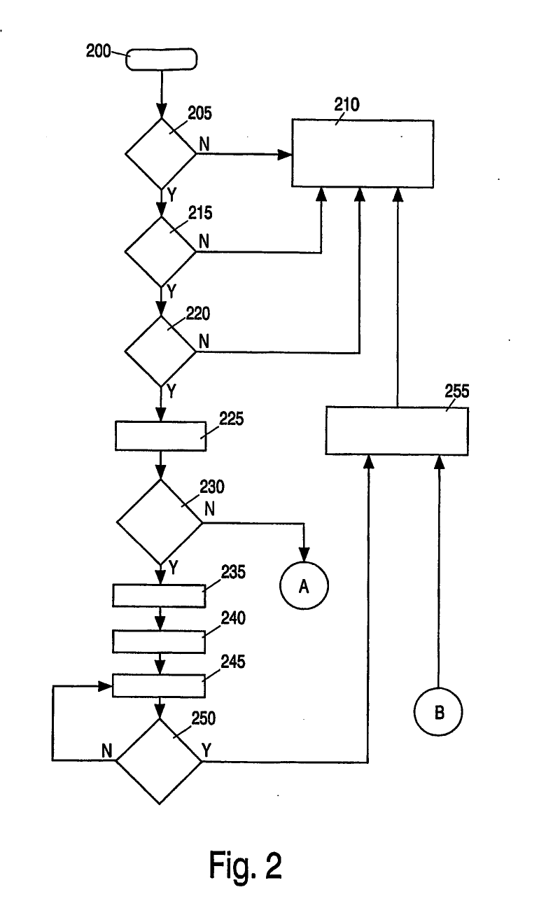

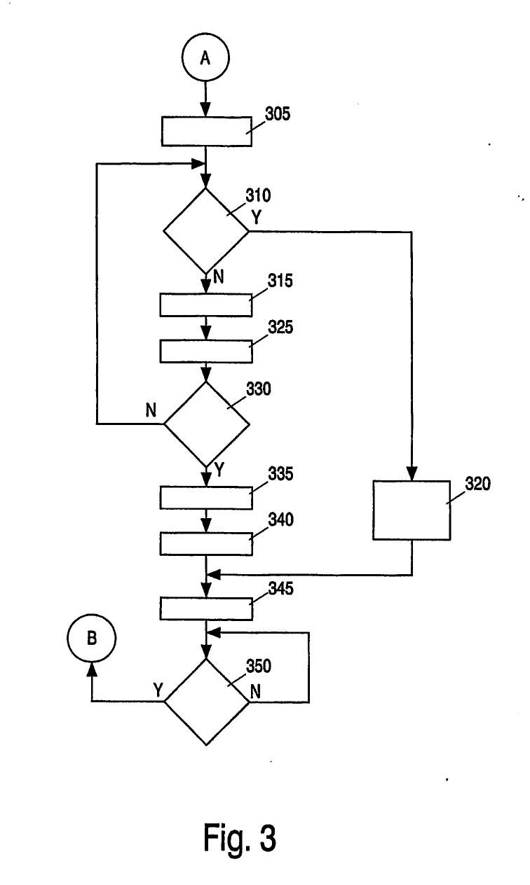

FIGS. 2 and 3 show a flowchart of a method according to the invention, which method is carried out in the system shown in FIG. 1.

FIG. 1 shows a system 1 for simulating the presence of a person in a room, which system 1 is formed by an audio stereo system 10, hereinafter referred to in brief as audio system 10. The audio system 10 has first playback means 11, which first playback means 11 are formed by what is referred to as a CD module 12. The CD module 12 is provided and designed for playing back digitally stored information or data, which digitally stored information is stored in data carriers which can be read in an optical manner. The optically readable data carriers are in this case formed by audio compact disks (audio CDs). The digitally stored information is stored in accordance with a CD standard (“red book”) in tracks on the data carriers, and is in this case sound information. It may be mentioned that the CDs may likewise be of the CD-R or CD-RW type. It may furthermore be mentioned that the first playback means 11 can also be formed by a DVD module and the data carriers may be formed by DVDs, on which DVDs sound and/or image information can be stored.

The audio system 10 furthermore has a CPU 50 which is provided as a central control unit, which CPU 50 is designed as a microprocessor and is connected to a ROM 20 provided as nonvolatile memory and to a RAM 21 provided as volatile memory. The ROM 20 and the RAM 21 are provided and designed for known purposes.

The audio system 10 furthermore comprises input means 13, said input means 13 having keys that can be operated manually, being mounted in the region of a casing wall of the audio system 10, being connected to the CPU 50 and being designed for the inputting of control information by a user of the audio system 10. It may be mentioned that such input means 13 can likewise be formed by a multifunctional remote control unit or a voice control unit or a personal computer (PC).

The audio system 10 also comprises a remote control sensor 14 which is connected to the CPU 50 and is designed to receive infrared remote control signals in accordance with the RC6 standard. The audio system 10 further comprises display means 15 for displaying text and/or image information. The display means 15 in the present case are formed by an LCD dot matrix display unit which is mounted visibly in the region of a casing wall of the audio system 10. It may be mentioned that such display means IS can likewise be formed by a VFD display or other similar displays.

The audio system 10 further comprises second playback means 16 which are connected to the CPU 50 and are formed by a tuner module 17, which tuner module 17 is designed to receive radio program sound and/or image information from various radio stations, that is to say transmitting stations. It may be mentioned that the second playback means 16 may also be formed by an Internet audio module, which Internet audio module is designed to play back radio program sound and/or image information transmitted via a data network, or be formed by what is referred to as a tape module, which tape module is designed to play back and/or record from/onto a magnetic tape accommodated in a cassette.

The audio system 10 also comprises an amplifier module 30 which is connected to the CPU 50 and is designed to amplify analog audio signals, which amplified analog audio signals are transmitted to an amplifier output 31. An audio playback means in the form of a loudspeaker 32 is connected to the amplifier output 31, said loudspeaker 32 being provided for playing back the amplified analog audio signals. In the present case, the CD module 12 and the tuner module 17 are each designed to transmit sound information, which sound information is transmitted as analog audio signals to the amplifier module 30. Furthermore, the audio system 10 comprises standby means 18 which are formed with the aid of a power supply module 19. The standby means 18 and hence also the power supply module 19 are designed to activate and deactivate a standby mode of operation of the audio system 10.

The CPU 50 comprises switching means 51 and activation signal generation means 52, which activation signal generation means 52 are formed by a timer 52. The activation signal generation means 52 are designed to automatically repeatedly generate an activation signal AS. The CPU 50 further comprises activation means 53 and CD module control means 55 and tuner module control means 56. Further details regarding said means 51, 52, 53, 55 and 56 are given below in connection with FIGS. 2 and 3.

The activation means 53 comprise time program monitoring means 57, to which time program monitoring means 57 the activation signal AS can be supplied. The activation means 53 further comprise delay means 58, which delay means 58 are connected downstream of the time program monitoring means 57 and are designed to transmit the activation signal AS to program selection control means 54 in a randomly delayed manner.

The switching means 51 are designed to switch the audio system 10 between a simulation mode of operation and an entertainment mode of operation. In the present case, this switching can be carried out using a switch key 13a of the input means 13. In the present case, such an entertainment mode of operation is desired by a user of the audio system 10, which audio system 10 is located in the lounge of the user's apartment in order to entertain the user for example by playing back a favorite CD using the CD module 12. It may be mentioned that an entertainment mode of operation of this type can likewise be understood to mean the recording of sound information, or a search for desired sound information.

For convenience, the audio system 10 is controlled by means of a remote control unit (not shown), with the audio system 10 in the present case advantageously having an energy-saving standby mode of operation.

Advantageously, the user can then put the audio system 10 in the simulation mode of operation when the user leaves his apartment for a relatively long period of time and the apartment is consequently unoccupied or unattended, for example during a holiday or trip. An unoccupied or unattended apartment such as this is unfortunately often a favored target of burglars wishing to gain access with criminal intent. In the simulation mode of operation of the audio system 10, the presence of a person in the apartment is simulated by sound information being transmitted, as a result of which the risk of the apartment being broken into can be minimized.

FIGS. 2 and 3 show a sequence of a simulation mode of operation, which sequence is illustrated using the audio system 10 and the CPU 50. Following actuation of the switch key 13a, the switching means 51 switch the audio system 10 to the simulation mode of operation, the sequence being started in the time program monitoring means 52 as a result of a timer routine activated by the timer 52 (activation signal generation means 52), said sequence starting at a start block 200. Following the start block 200, an interrogation is made at an interrogation block 205 as to whether the audio system 10 is in a standby mode of operation. If the audio system 10 is in a standby mode of operation, then the sequence branches to an interrogation block 215; otherwise the sequence continues at a block 210.

Time information in the form of hours and minutes is transmitted by the timer 52 as activation signal AS. At the interrogation block 215, a check is made as to whether the time information transmitted by the timer 52 lies within a time window, a time window from nine (9) hours and zero (0) minutes (9:00) to twenty-two (22) hours and zero (0) minutes (22:00) being predefined in the present case. It may be mentioned that other time windows can be predefined, for example from 7:00 to 23:00 or from 18:00 to 22:00, and these time windows can be selected and/or set by the user.

Depending on the interrogation at the interrogation block 215, if the time information transmitted by the timer 52 lies within the time window, the activation signal AS is transmitted to the delay means 58 and the sequence continues at an interrogation block 220; otherwise the sequence continues at the block 210. At the block 210, the timer 52 is reset and restarted, the timer 52 being set to two (2) minutes in the present case, that is to say that after a period of two (2) minutes the timer routine is started again and the sequence begins again at the block 200. It may be mentioned that the timer 52 can be set to another time period, for example to six (6) hours or one day.

The transmission of the activation signal AS to the program selection control means 54 is randomly delayed by the delay means 58, by a random number being generated by means of random number generator means (not shown in any more detail) and by a decision being made, at the interrogation block 220, as a function of the random number, as to whether the activation signal AS is forwarded as an alarm signal WS to the program selection control means 54. In the event of a positive response “Y” at the interrogation block 220, the sequence continues at a block 225. In the event of a negative response “N”, the sequence continues at the block 210.

At the block 225, the standby means 18 activate the audio system 10, following which activation the playback of sound information by means of the CD module 12 is enabled. After the block 225, an interrogation will be performed with the aid of the program selection control means 54 and the CD module control means 55, at the interrogation block 230, as to whether the CD module 12 contains a CD for playback. If a CD is present, then the sequence continues at a block 235, in which block 235 the program selection control means 54 select or create a sequence of tracks contained on the CD. In the present case, the CD contains five (5) different tracks, said tracks each containing different sound information characteristic of the presence of a person in the apartment, such as kitchen noises (hand mixer, clattering of dishes, etc.), the noise of a room being cleaned or the noise of a conversation or discussion for example. In the present example of an embodiment, the tracks are selected in a random manner. However, it should be mentioned that the sequence of tracks can be predefined.

Following the block 235, at a black 240 the program selection control means 54 create a playback program from the selected tracks. In the present case, a playback program using just one track—track four (4)—of the CD is created. The sequence then continues at a block 245, where the CD module control means 55 transmit the playback program to the CD module 12 and the CD module 12 commences playback of a track of the playback program, after which the sequence continues at a block 250. At the block 250, the program selection control means 54 check whether the playback of the track of the playback program by the CD module 12 has finished. If all tracks of the playback program have been played back, the sequence continues at a block 255; otherwise the sequence continues at the block 245, that is to say a subsequent track of the playback program is played back.

If, during the interrogation at the interrogation block 230, it is ascertained that no CD is present in the CD module 12, the sequence continues at a block 305, which block 305 is illustrated in FIG. 3 and is connected to the sequence shown in FIG. 2 via a connection point A. The sequence described below according to FIG. 3 shows one possibility for simulating the presence of a person in a room if it is not possible for the CD module 12 to play back the CD, for example if someone has forgotten to place such a CD in the CD module 12. It should be mentioned that, during the interrogation at the block 230, an interrogation may be made as to whether a CD present in the CD module 12 can or cannot be played.

At the block 305, the program selection control means 54 activate the second playback means 16, that is to say also the tuner module 17, and deactivate the CD module 12. Furthermore, a continuous counting variable PAS is set to a value of zero. After the block 305, the sequence branches at an interrogation block 310, specifically to a block 320 if the continuous counting variable PAS has a value greater than one thousand (1000) or to a block 315 if the aforementioned condition is not met. At the block 315, a frequency preset of the tuner module 17 is selected, giving a selection frequency AF, after which the continuous counting variable PAS is increased by a value of one (1) at a block 325. Thereafter, at an interrogation block 330, a check is made as to whether the selection frequency AF corresponds to a valid frequency of the tuner module 17. If it does, the sequence continues at a block 335; otherwise the sequence continues at the block 310 and a frequency preset of the tuner module 17 is selected anew.

At the block 335, a playback duration is specified, within which playback duration the tuner module 17 plays back sound information in order to simulate the presence of a person in a room. In the present case, the playback duration is selected at random to be between two (2) minutes and fifteen (15) minutes, and then the sequence continues at a block 340, at which block 340 a tuner timer is started.

In the case where the continuous counting variable PAS has a value greater than one thousand (1000) at the interrogation block 310, the sequence continues with a frequency setting of the tuner module 17 most recently selected by the user being determined as the selection frequency AF at the block 320.

After the block 340 or the block 320, at a block 345, tuner module control means 56 convey the selection frequency AF to the tuner module 17 with subsequent activation of the tuner module 17 in order to transmit sound information. The sequence then continues at an interrogation block 350, at which interrogation block 350 the started tuner timer continually checks whether the playback duration has already elapsed. If this is the case, the sequence continues at the block 255, as shown in FIG. 3 by means of the connection point B.

At the block 255, in the present case the power supply module 19 switches the audio system 10 to an energy-saving standby mode, after which the sequence continues at the block 210, that is to say the timer 52 is restarted. e entertainment mode of operation.

1. A system (1) for simulating the presence of a person in a room, which system (1) comprises the following means, namely:
first playback means (11) for playing back sound and/or image information and activation signal generation means (52) for repeatedly generating an activation signal (AS), and
activation means (53) for automatically repeatedly activating the first playback means (11) as a function of the occurrence of the activation signal (AS), following which activation of the first playback means (11) sound and/or image information can be transmitted, by means of which transmittable sound and/or image information the presence of a person in a room can be simulated, and
standby means (18) for activating/deactivating a standby mode of operation of at least the first playback means (11), and
switching means (51) for switching at least the first playback means (11) of the system (1) between a simulation mode of operation and an entertainment mode of operation, in which simulation mode of operation it is possible to simulate the presence of a person in a room and in which entertainment mode of operation it is possible for a user to switch at least the first playback means (11) between the standby mode of operation and the entertainment mode of operation.

2. A system (1) as claimed in claim 1, wherein there are delay means (58) by which means it is possible for the activation of the first playback means (11) to be randomly delayed.

3. A system (1) as claimed in claim 1, wherein there are program selection control means (54) for selecting a sound and/or image information program, which sound and/or image information program can be played back by means of the first playback means (11).

4. A system (1) as claimed in claim 1, wherein the first playback means (11) are designed to play back sound and/or image information from a data carrier, on which data carrier the sound and/or image information is stored such that it can be read in an optical manner.

5. A system (1) as claimed in claim 4, wherein noises typical of the presence of a person are stored on the data carrier.

6. A system (1) as claimed in claim 3, wherein there are second playback means (16) for playing back sound and/or image information, and wherein the activation means (53) are designed to activate the second playback means (16) when no sound and/or image information program that can be played back by means of the first playback means (11) can be selected will the aid of the program selection control means (54).

7. A system (1) as claimed in claim 6, wherein the second playback means (16) are designed to play back sound and/or image information that has been transmitted by a transmitting station.

8. A system (1) as claimed in claim 3, wherein control means (50, 54) are provided for controlling the standby means (18), with the aid of which control means (50, 54) the standby mode of operation can be activated by the standby means (18) following the playback of the sound and/or image information.

9. A system (1) as claimed in claim 1, wherein the system (1) is designed as an audio stereo system (10).

10. A method of simulating the presence of a person in a room, in which method the following steps are carried out, namely:
playback of sound and/or image information by means of first playback means (11), and
repeated generation of an activation signal (AS), and
automatic repeated activation of the first playback means (11) as a function of the occurrence of the activation signal (AS), following which activation of the first playback means (11) sound and/or image information is transmitted, by means of which transmitted sound and/or image information the presence of a person in a room is simulated, and
activation/deactivation of a standby mode of operation of at least the first playback means (11), and
switching of at least the first playback means (11) of the system between a simulation mode of operation and an entertainment mode of operation, in which simulation mode of operation the presence of a person in a room is simulated and in which entertainment mode of operation a user switches at least the first playback means (11) between the standby mode of operation and the entertainment mode of operation.

11. A method as claimed in claim 10, wherein a sound and/or image information program is selected, which sound and/or image information program is played back by means of the first playback means (11).

12. A method as claimed in claim 10, wherein the first playback means (11) are used to play back sound and/or image information from a data carrier, on which data carrier the sound and/or image information is stored such that it can be read in an optical manner.

13. A method as claimed in claim 10, wherein second playback means (16) are activated when no sound and/or image information program for the first playback means (11) can be selected.
